(19) United States
(12) Patent Application Publication
(10) Pub. No.: US 2020/0363677 A1
(43) Pub. Date: Nov. 19, 2020

(54) DISPLAY APPARUTUS AND MANUFACTURING METHOD THEREOF

(71) Applicant: Samsung Electronics Co., Ltd., Suwon-si, Gyeonggi-do (KR)

(72) Inventors: Jin Soo KIM, Seoul (KR); You Jin CHOI, Suwon-si (KR)

(73) Assignee: Samsung Electronics Co., Ltd., Suwon-si, Gyeonggi-do (KR)

(21) Appl. No.: 16/957,987

(22) PCT Filed: Sep. 6, 2018
(86) PCT No.: PCT/KR2018/010425

§ 371 Date: Jun. 25, 2020

(30) Foreign Application Priority Data
Dec. 26, 2017 (KR) 10-2017-0179409

(51) Int. Cl. G02F 1/1333; C25D 11/24

(52) U.S. Cl. CPC G02F 1/133308; C25D 11/246; G02F 2001/13332; G02F 2001/133314; G02F 2001/133311

(57) ABSTRACT

Disclosed embodiment provides a display apparatus including a polysiloxane layer formed by using a polysiloxane containing a pigment on the surface of an aluminum oxide layer of a display apparatus chassis. A display apparatus according to an embodiment includes: a display panel; and a chassis disposed on the outside of the display panel, and the chassis includes an aluminum oxide layer; and a polysiloxane layer disposed on the aluminum oxide layer, on its surface.

### TECHNICAL FIELD

The present disclosure relates to a display apparatus.

### BACKGROUND ART

A display apparatus includes a display panel for displaying images to display broadcasting signals or various formats of image data.

The display panel includes a self-emissive display panel and a non-emissive display panel. The self-emissive display panel includes a Cathode Ray Tube (CRT) panel, an Electro Luminescence (EL) panel, an Organic Light Emitting Diode (OLED) panel, a Vacuum Fluorescence Display (VFD) panel, a Field Emission Display (FED) panel, a Plasma Display Panel (PDP) panel, etc., and the non-emissive display panel includes a Liquid Crystal Display (LCD) panel.

The LCD panel includes a back light unit to emit white light, and a display panel to transmit or block light emitted from the back light unit.

### DISCLOSURE

Therefore, it is an aspect of the disclosure to provide a display apparatus comprising a polysiloxane layer formed using a polysiloxane containing a pigment on the surface of an aluminum oxide layer of a display apparatus chassis.

In accordance with one aspect of the disclosure, a display apparatus includes: a display panel; and a chassis disposed on the outside of the display panel, and the chassis includes an aluminum oxide layer; and a polysiloxane layer disposed on the aluminum oxide layer, on its surface.

The polysiloxane layer may further include an acrylic.

The polysiloxane layer may include at least one of a white pigment, a blue pigment, a green pigment and a yellow pigment.

The polysiloxane layer may include a white pigment including at least one of a white lead, a zinc oxide, a zinc sulfide, an antimony oxide and a titanium oxide. The polysiloxane layer may include a blue pigment including at least one of 2CoO.Cr₂O₃.Al₂O₃, CoO.Al₂O₃ and copper phtalocyanine.

The polysiloxane layer may include a green pigment including at least one of chloride copper phthalocyanine and bromide copper phthalocyannine.

The polysiloxane layer may include a yellow pigment including at least one of lead chromate (PbCrO₄), lead sulfate (PbSO₄), cadmium sulfide, hydrated ferric oxide (Fe₂O₃.H₂O) and BaCrO₄.

In accordance with another aspect of the disclosure, a manufacturing method of a display apparatus includes: forming an aluminum oxide layer by performing anodizing on the chassis surface of the display apparatus; and forming a polysiloxane layer on the aluminum oxide layer by using pigment and polysiloxane.

The polysiloxane layer may further include an acrylic.

The forming the polysiloxane layer may include: forming the polysiloxane layer on the aluminum oxide layer using a dipping or spray method.

The pigment may include at least one of a white pigment, a blue pigment, a green pigment and a yellow pigment.

The pigment may include a white pigment including at least one of a white lead, a zinc oxide, a zinc sulfide, an antimony oxide and a titanium oxide.

The pigment may include a blue pigment including at least one of 2CoO.Cr₂O₃.Al₂O₃, CoO.Al₂O₃ and copper phtalocyanine.

The pigment may include a green pigment including at least one of chloride copper phthalocyanine and bromide copper phthalocyannine.

The pigment may include a yellow pigment including at least one of lead chromate (PbCrO₄), lead sulfate (PbSO₄), cadmium sulfide, hydrated ferric oxide (Fe₂O₃.H₂O) and BaCrO₄.

According to the display apparatus according to the disclosed embodiment, an conventional coloring and sealing process can be replaced with one process for forming a polysiloxane layer.

In addition, according to the display apparatus according to the disclosed embodiment, it is possible to provide improved surface hardness and corrosion resistance compared to the conventional anodizing method.

In addition, according to the display apparatus according to the disclosed embodiment, a chassis in which various and clear colors are implemented may be included.

### DESCRIPTION OF DRAWINGS

FIG. 1 illustrates an external appearance of a display apparatus according to an embodiment of the present disclosure.

FIG. 2 illustrates an exploded perspective view of a display apparatus according to an embodiment of the present disclosure.

FIG. 3 illustrates a cross-sectional view of a display apparatus according to an embodiment of the present disclosure.

FIG. 4 illustrates a quantum dot sheet of a display apparatus according to an embodiment of the present disclosure.

FIG. 5 illustrates a chassis surface layer formed by an anodizing method according to an embodiment of the present disclosure.

FIG. 6 illustrates a manufacturing method of a display apparatus according to an embodiment of the present disclosure.

### MODE OF THE INVENTION

Configurations illustrated in the embodiments and the drawings described in the present specification are only the preferred embodiments of the present disclosure, and thus it is to be understood that various modified examples, which may replace the embodiments and the drawings described in the present specification, are possible when filing the present application.

The terms used in the present specification are used to describe the embodiments of the present disclosure. Accordingly, it should be apparent to those skilled in the art that the following description of exemplary embodiments of the present invention is provided for illustration purpose only and not for the purpose of limiting the invention as defined by the appended claims and their equivalents. It is to be understood that the singular forms “a,” “an,” and “the” include plural referents unless the context clearly dictates otherwise. It will be understood that when the terms “includes,” “comprises,” “including,” and/or “comprising,” when used in this specification, specify the presence of stated features, figures, steps, components, or combination thereof, but do not preclude the presence or addition of one or more other features, figures, steps, components, members, or combinations thereof.

It will be understood that, although the terms first, second, etc. may be used herein to describe various components, these components should not be limited by these terms. These terms are only used to distinguish one component from another. For example, a first component could be termed a second component, and, similarly, a second component could be termed a first component, without departing from the scope of the present disclosure. As used herein, the term “and/or” includes any and all combinations of one or more of associated listed items.

As used herein, the terms “unit”, “device, “block”, “member”, or “module” refers to a unit that can perform at least one function or operation, and may be implemented as a software or hardware component such as a Field Programmable Gate Array (FPGA) or an Application Specific Integrated Circuit (ASIC). However, the term “unit”, “device”, “block”, “member”, or “module” is not limited to software or hardware. The “unit”, “device”, “block”, “member”, or “module” may be stored in accessible storage medium, or may be configured to run on at least one processor.

Hereinafter, an embodiment of the present disclosure will be described in detail with reference to the appended drawings.

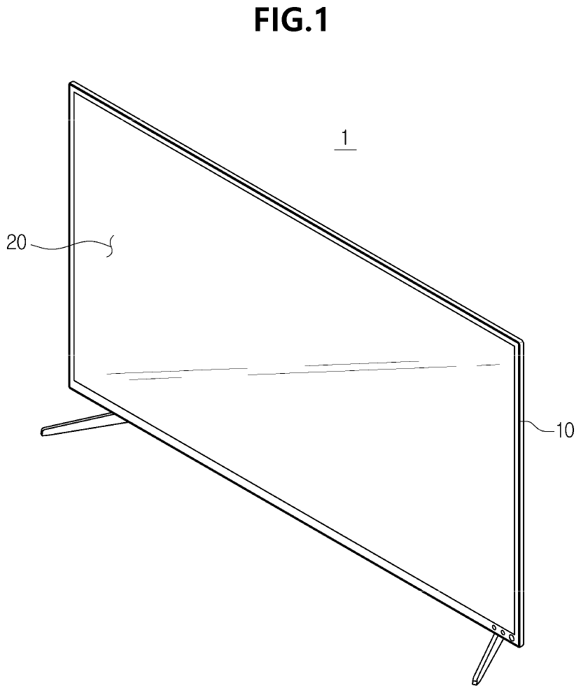

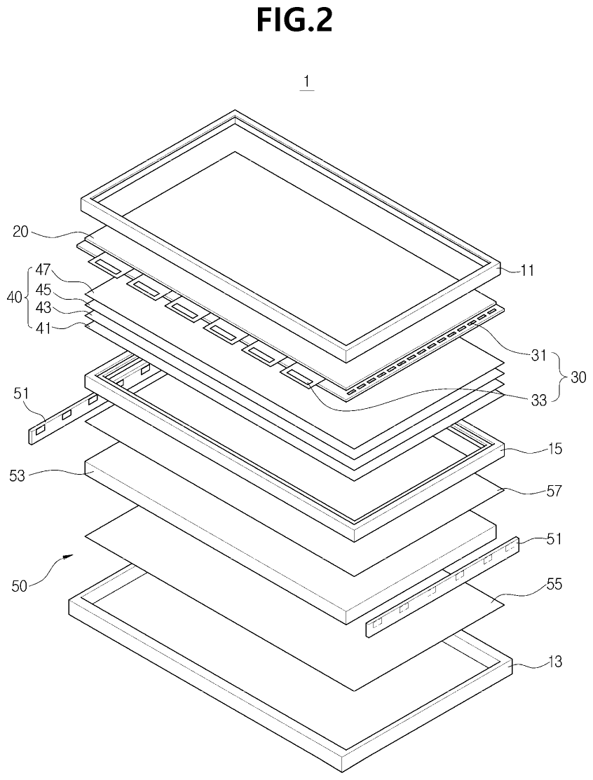

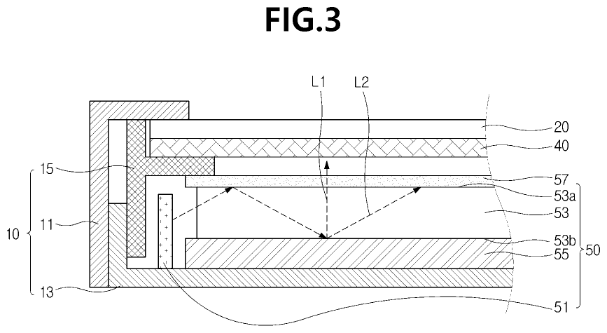

FIG. 1 illustrates an external appearance of a display apparatus according to an embodiment of the present disclosure. FIG. 2 illustrates an exploded perspective view of a display apparatus according to an embodiment of the present disclosure. FIG. 3 illustrates a cross-sectional view of a display apparatus according to an embodiment of the present disclosure.

Referring to FIG. 1, a display apparatus 1 is an apparatus capable of processing image signals to create an image, and visually displaying the image. Hereinafter, an example in which the display apparatus 1 is television (TV) is shown. However, the display apparatus 1 may be any other device, such as a monitor, a portable multimedia device, and a portable communication device, which can visually display images.

Referring to FIGS. 1 to 3, the display apparatus 1 may include a main body 10 to accommodate various components, and a display panel 20 to display an image that a user can recognize. The main body 10 may include a driving circuit 30, a back light unit 50, and an optical sheet 40.

The main body 10 may include a top chassis 11 provided in the front part of the display apparatus 1, a bottom chassis 13 provided in the back part of the display apparatus 1, and a mold frame 15 provided in the inside of the display apparatus 1.

The top chassis 11 may be disposed to surround a surface of the display panel 20 on which images are displayed, thus preventing the edges of the display panel 20 from being exposed to the outside.

The bottom chassis 13 may be disposed to surround the other surface of the display panel 20, which is opposite to the surface on which images are displayed, thus preventing various components included in the display apparatus 1 from being exposed to the outside. Also, the bottom chassis 13 may protect various components included in the display apparatus 1 from an external impact.

The mold frame 15 may limit movements of the display panel 20, the optical sheet 40, and the back light unit 50, and fix the display panel 20, the optical sheet 40, and the back light unit 50 in the top chassis 11 and the bottom chassis 13.

Aluminum oxide layer 510 and polysiloxane layer 520 formed through an anodizing method are provided on the surfaces of the top chassis and the bottom chassis according to the disclosed embodiment. Detailed description thereof will be described later.

The display panel 20 may display various images according to image signals received from the outside. The display panel 20 may be a self-emissive display panel in which a plurality of pixels configuring the display panel 20 themselves emit light to create an image, or a non-emissive display panel in which a plurality of pixels reflect/transmit/block light to create an image.

In the following description, it is assumed that the display panel 20 is a non-emissive display panel to reflect/transmit/block light emitted from the back light unit 50 to create an image.

The display panel 20 may include a liquid crystal layer (not shown), a pair of transparent electrode layers (not shown), a pair of transparent substrates (not shown), and a color filter array (not shown).

The liquid crystal layer may include liquid crystal, wherein the liquid crystal is a material in the intermediate state between crystal and liquid. The liquid crystal may show optical properties according to a change of an applied voltage. For example, the liquid crystal may change its molecular arrangement according to a change of an applied electric field.

On both sides of the liquid crystal layer, the pair of transparent electrode layers may be provided to form an electric field in the liquid crystal layer. An electric field that is applied to the liquid crystal layer may change according to a voltage applied between the pair of transparent electrode layers.

The transparent electrode layers may include a plurality of gate lines (not shown), a plurality of data lines (not shown), and a plurality of thin film transistors (TFTs).

The gate lines may be arranged in a row direction to turn on/off the TFTs according to gate signals, and the data lines may be arranged in a column direction to transfer data signals to the plurality of pixels through the TFTs. An electric field that is applied to the liquid crystal layer may change according to the gate signals input through the gate lines and the data signals input through the data lines, and the change of the electric field may change the molecular arrangement of liquid crystal. Also, the molecular arrangement of liquid crystal enables the liquid crystal layer to transmit or block light.

The gate lines and the data lines may be formed with Indium Tin Oxide (ITO) or Indium Zinc Oxide (IZO).

The pair of transparent substrates (not shown) may form an external appearance of the display panel 20, and protect the liquid crystal layer and the transparent electrode layers. The transparent substrates may be fabricated with tempered glass or a transparent film having high light transmittance.

The color filter layer may include a red filter, a blue filter, and a green filter formed in an area corresponding to each pixel so that the plurality of pixels configuring the display panel 20 can display colors independently.

As such, the display panel 20 may block or transmit light generated by the back light unit 50 which will be described below, to thereby create an image. More specifically, the individual pixels configuring the display panel 20 may block or transmit light emitted from the back light unit 50 to thereby create an image having various colors.

The driving circuit 30 may provide a driving signal for driving the display panel 20 to the display panel 20. The driving circuit 30 may include a gate driving circuit 31 and a data driving circuit 33.

The gate driving circuit 31 may be connected to the gate lines of the display panel 20 to transfer gate signals to the gate lines. Also, the data driving circuit 33 may be connected to the data lines of the display panel 20 to transfer data signals to the data lines.

The back light unit 50 may be disposed behind the display panel 20, and generate light that is used by the display panel 20 to create an image. The back light unit 50 may be an edge type back light unit in which light sources are disposed along edges, or a direct type back light unit in which light sources are disposed behind the display panel 20.

In the following description, the back light unit 50 is assumed to be an edge type back light unit in which light sources are disposed along edges, however, a quantum dot sheet 57 which will be described later may also be applied to a direct type back light unit.

The back light unit 50 may include, as shown in FIG. 3, a light source 51 configured to generate light, a light guide plate 53 configured to convert light generated by the light source 51 into sheet light, a reflector sheet 55 provided behind the light guide plate 53 and configured to reflect light output from the light guide plate 53, and the quantum dot sheet 57 configured to receive light from the light guide plate 53 and to output white light (light resulting from mixing light of various colors). If the back light unit 50 is a direct type back light unit, a plurality of light sources may be arranged on the front surface of the reflector sheet 55, and a diffusion plate, instead of the light guide plate 53, may be used.

The light source 51 may be, as shown in FIG. 3, positioned along an edge of the light guide plate 53, to output light toward the light guide plate 53.

The light source 51 may output light (monochromatic light) of a single wavelength (single color), or light (white light) resulting from mixing light of a plurality of wavelengths. Since the back light unit 50 includes the quantum dot sheet 57, the light source 51 may be a light source of outputting monochromatic light, specifically, light of a blue color having a short wavelength. In the following description, the light source 51 is assumed to output light of a blue color (hereinafter, simply referred to as blue light).

The light source 51 may be Light Emitting Diode (LED) or Cold Cathode Fluorescence Lamp (CCFL) having a low amount of heat generation.

In the edge type back light unit 50, the light guide plate 53 may change a propagating direction of light incident to the lateral side so as to cause the light to exit the front surface 53a. In order to change the propagating direction of light, a plurality of convex stripe patterns may be formed on the front surface 53a of the light guide plate 53, and a plurality of dots may be formed on the rear surface 53b of the light guide plate 53. The sizes and intervals of the convex stripe patterns and the dots may be adjusted to uniformly emit light toward the front surface 53a of the light guide plate 53.

Also, the convex stripe patterns formed on the front surface 53a of the light guide plate 53 may be patterns embossed through a printing method, and the dots formed on the rear surface 53b of the light guide plate 53 may be dots engraved using laser.

As shown in FIG. 3, a part L1 of light incident to the inside of the light guide plate 53 may be scattered by the dots formed on the rear surface 53b of the light guide plate 53 and then exit the front surface 53a of the light guide plate 53, and the other part L2 of the light may be reflected to the inside of the light guide plate 53 by the reflector sheet 55 provided on the rear surface 53b of the light guide plate 53. The reflected light L2 may arrive at the center area of the light guide plate 53, and be scattered at the center area of the light guide plate 53 to then exit the front surface 53a of the light guide plate 53.

As such, due to refraction, reflection, and scattering of light occurred in the inside of the light guide plate 53, the light guide plate 53 may emit light uniformly through the front surface 53a.

The light guide plate 53 may be made of poly methyl methacrylate (PMMA) or polycarbonate (PC) having transparency and high strength.

The reflector sheet 55 may be provided on the rear surface of the light guide plate 53, as described above, and may reflect a part of light arrived at the rear surface 53a of the light guide plate 53 to the inside of the light guide plate 53.

The reflector sheet 55 may be fabricated by coating a base material with a material having high reflectivity. For example, the reflector sheet 55 may be fabricated by coating a base material such as polyethylene terephthalate (PET) with polymer having high reflectivity.

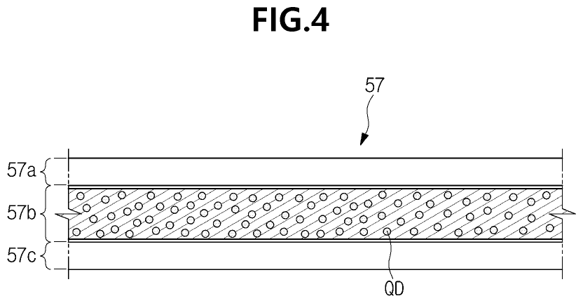

The quantum dot sheet 57 may convert the light exiting the front surface 53b of the light guide plate 53 into white light. FIG. 4 shows the quantum dot sheet 57 according to an embodiment of the present disclosure.

As shown in FIG. 4, the quantum dot sheet 57 according to an embodiment of the present disclosure may include a fluorescent member 57b including quantum dots QD, and barrier films configured to prevent the quantum dots QD from being exposed to oxygen or moisture. The barrier films may include a first barrier film 57c disposed on the rear surface of the fluorescent member 57b, and a second barrier film 57a disposed on the front surface of the fluorescent member 57b.

The quantum dot QD is a small globe-shaped semiconductor particle having a nanometer size (nm, 1/1,000,000,000 m), and may be composed of a central body having a size of about 2 to 10 nm and a shell made of zinc sulfide ZnS. The central body of the quantum dot QD may be made of cadmium selenite CdSe, cadmium telluride CdTe, or cadmium sulfide CdS.

If a voltage is applied to the quantum dot QD, the quantum dot QD emits light or absorbs light to emit light of a specific wavelength.

The electrons of the quantum dots QD are at a low energy level (or band) in a stable state. In this state, if the quantum dots QD absorb light from the outside, the electrons at the low energy level transit to a high energy level (or band). Since the electrons at the high energy level are in an unstable state, the electrons again transit from the high energy level to the low energy level. When the electrons transit from the high energy level to the low energy level, the electrons may emit light corresponding to an energy difference between the high energy level and the low energy level. The wavelength of the emitted light may be decided by the energy difference between the high energy level and the low energy level.

Particularly, the smaller size of a quantum dot QD emits light of the shorter wavelength, and the larger size of a quantum dot QD emits light of the longer wavelength. For example, a quantum dot QD having a diameter of 2 nm may emit blue light, and a quantum dot QD having a diameter of about 10 nm may emit red light.

Also, quantum dots QD of various sizes may be used to output various wavelengths of light ranging from red light to blue light. In other words, quantum dots QD having various sizes may be used to generate light (white light) having natural colors. The fluorescent member 57b of the quantum dot sheet 57 may be fabricated by distributing the quantum dots QD in a resin. The resin may be made of a polymer acrylate resin material.

Each of the barrier films 57a and 57c may be formed with polyethylene terephthalate (PET), and may include a transparent film to protect the fluorescent member 57b from an external force, and a barrier layer coated on the transparent film in order to prevent moisture and oxygen from permeating the fluorescent member 57b. The barrier layer may also be formed with silicon oxide SiO or SiO₂ for transparency.

If light is incident to the quantum sheet 57 from the light guide plate 53, the incident light may excite electrons of the quantum dots QD included in the quantum dot sheet 57. In other words, electrons at a low energy level (or band) of the quantum dots QD may transit to a high energy level (or band) by the incident light.

When the excited electrons transit from the high energy level to the low energy level, the quantum dots QD may output light (white light) of various wavelengths according to their sizes. The light of various wavelengths may form an image through the optical sheet 40 and the display panel 20.

As described above, the back light unit 50 may include the light source 51, the light guide plate 53, the reflector sheet 55, and the quantum dot sheet 57 to emit uniform sheet light.

The optical sheet 40 may refract or scatter light in order to widen a viewing angle of the display apparatus 1 and increase the brightness of the display apparatus 1. The optical sheet 40 may include various sheets. For example, the optical sheet 40 may include a diffusion sheet 41, a prism sheet 43, a protection sheet 45, and a Double Brightness Enhancement Film (DBEF) 47 (see FIG. 2).

The diffusion sheet 41 may diffuse light emitted from the back light unit 50 over the surface so that the entire screen of the display apparatus 1 shows uniform colors and brightness. Since the light emitted from the light guide plate 53 passed through the patterns formed on the front surface 53a of the light guide plate 53, the patterns formed on the front surface 53a of the light guide plate 53 may be recognized from the light emitted from the light guide plate 53.

In order to prevent the patterns formed on the front surface 53a of the light guide plate 53 from being recognized from the light emitted from the light guide plate 53, the diffusion sheet 41 may diffuse the light emitted from the light guide plate 53 in a direction that is vertical to the emitting direction of the light.

In other words, the diffusion sheet 41 may diffuse light emitted from the back light unit 50 to maintain the brightness of the entire screen uniform. According to another embodiment, instead of the diffusion sheet 41, a microlens sheet which can diffuse light, like the diffusion sheet 41, and widen a viewing angle may be used.

While the light passing through the diffusion sheet 41 is diffused in the direction that is vertical to the surface of the diffusion sheet 41, the brightness of the light may be sharply reduced. The prism sheet 43 may refract or focus the light diffused by the diffusion sheet 41 to thereby increase the brightness of the light.

The prism sheet 43 may include a plurality of prism patterns, each having a trigonal prism shape, and the prism patterns may be arranged adjacent to each other so as to form a plurality of bands. That is, the prism patterns may be repetitive patterns of mountains and valleys, and may protrude in rows toward the display panel 20

The protection sheet 45 may protect various components included in the back light unit 50 from an external impact or foreign materials. Since the prism sheet 43 is vulnerable to scratches, the protection sheet 45 may prevent the prism sheet 43 from being scratched.

The DBEF 47 may be a kind of a polarizing film, and is also called a reflective polarizing film. The DBEF 47 may transmit polarized light incident in a direction that is parallel to the polarizing direction of the DBEF 47, among light emitted from the back light unit 50, and reflect polarized light incident in a direction that is different from the polarizing direction of the DBEF 47, among the light emitted from the back light unit 50.

The light is a traverse wave that vibrate in a direction that is vertical to its propagation direction. The polarizing film may transmit light vibrating in a specific direction and absorb light vibrating in the other directions.

As described above, the DBEF 47 may reflect polarized light incident in a direction that is different from the polarizing direction of the DBEF 47.

Meanwhile, an aluminum oxide layer 510 through an anodizing method is formed on the chassis surface to improve color and corrosion resistance. In general, the anodizing method is a process of realizing color and corrosion resistance by forming an aluminum oxide layer 510 on an aluminum surface by performing a process of pickling/washing/anodizing/sealing on aluminum processed into the chassis shape of a display apparatus.

More specifically, the anodizing method generally forms an aluminum oxide (Al₂O₃) layer on the aluminum surface through a process of degreasing, rinsing, etching, polishing, rinsing, desmutting, rinsing, anodizing, rinsing, coloring, rinsing, sealing, rinsing, drying

In general, in the case of the anodizing method, only dyes and metal pigments (inorganic pigments) can be used in the coloring process, so there is a limit to the color that can be realized. Also, hydration sealing treatment/metal salt sealing treatment/organic sealing treatment, which is a general sealing method used for general anodizing methods, uses nickel fluoride, etc., and there is an environmental problem. After sealing, the hardness is formed at the maximum level of 1H˜2H.

The chassis of the display apparatus according to the disclosed embodiment applies a ceramic layer such as polysiloxane as the last layer formed during the anodizing method, thereby simplifying the process and providing various colors and excellent surface hardness and corrosion resistance. Hereinafter, an anodizing method applied to the display apparatus chassis according to the disclosed embodiment will be described in detail.

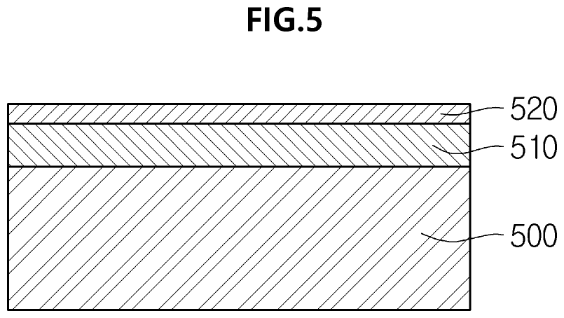

FIG. 5 illustrates a chassis surface layer formed by an anodizing method according to an embodiment of the present disclosure.

As illustrated in FIG. 5, the chassis surface of the display apparatus according to the disclosed embodiment includes an aluminum oxide layer 510 formed by an anodizing process on the aluminum 500 surface and a polysiloxane layer 520 formed on the aluminum oxide layer 510.

The aluminum oxide layer 510 formed on the aluminum 500 surface is formed by an anodizing method. The polysiloxane layer 520 formed on the aluminum oxide layer 510 may be formed by dipping or spraying method.

The polysiloxane layer 520 may be formed by applying a polysiloxane containing pigment onto the aluminum oxide layer 510 by the above-described dipping or spraying method.

The polysiloxane constituting the polysiloxane layer 520 may be composed of only polysiloxane or a combination of acrylic and polysiloxane.

The pigment included in the polysiloxane layer 520 may include at least one of white pigment, blue pigment, green pigment, and yellow pigment. The white pigment may include at least one of White Lead, Zinc Oxide, Zinc Sulfide, Antimony Oxide and Titanium Oxide The blue pigment may include at least one of 2CoO.Cr₂O₃.Al₂O₃, CoO.Al₂O₃ and Copper Phtalocyanine. The green pigment may include at least one of Chloride Copper Phthalocyanine and Bromide Copper Phthalocyannine. The yellow pigment may include at least one of Lead Chromate (PbCrO₄), Lead Sulfate (PbSO₄), Cadmium Sulfide, Hydrated Ferric Oxide (Fe₂O₃.H₂O) and BaCrO₄. The above-mentioned color and type of pigment are only examples, and the color or type of pigment is not limited thereto.

In general, the anodizing method includes coloring and sealing processes as separate processes, as described above. However, in the anodizing method according to the disclosed embodiment, it is possible to implement color while replacing the coloring process and the sealing process performed in separate processes with a single process of forming a polysiloxane containing pigment on an aluminum oxide layer 510.

In addition, in general, in the case of the coloring process in the anodizing method, only dyes and inorganic pigments can be used limitedly, so there is a limit to the color that can be realized. However, as described above, the pigment included in the polysiloxane layer 520 according to the disclosed embodiment may include not only inorganic pigments but also organic pigments, and thus various colors can be implemented.

In the case of forming a polysiloxane layer (520), an improved hardness is exhibited than that of a general anodizing method. As described above, after coating the polysiloxane on the aluminum oxide layer 510 by dipping or spraying, after drying at 150° C. for 20 minutes, the hardness test was conducted through a pencil hardness test. As a result, while the pencil hardness of the chassis surface subjected to the general coloring and sealing process is included in the range of 1H to 2H, the pencil hardness of the chassis surface on which the polysiloxane layer 520 is formed is included in the improved 4H to 6H range according to the disclosed embodiment.

As described above, the anodizing method according to the disclosed embodiment can replace the coloring and sealing process with one process of forming the polysiloxane layer 520 by forming the polysiloxane layer 520 on the aluminum oxide layer 510, and it is possible to realize various colors and improved hardness.

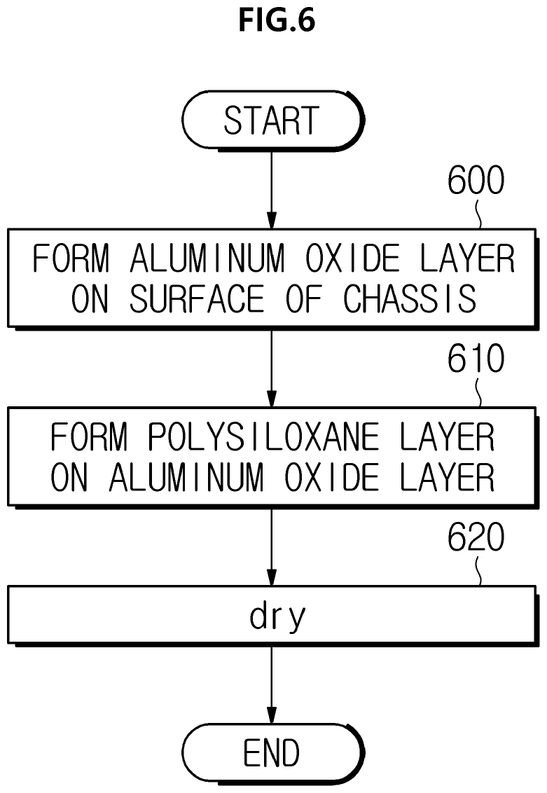

FIG. 6 illustrates a manufacturing method of a display apparatus according to an embodiment of the present disclosure.

Referring to FIG. 6, a manufacturing method of a display apparatus according to the disclosed embodiment includes a process of forming an aluminum oxide layer 510 on an aluminum 500 surface of the chassis through an anodizing process (600) and of drying the chassis (620) after forming a polysiloxane layer 520 on the aluminum oxide layer 510 (610).

The anodizing method according to the disclosed embodiment forms an aluminum oxide (Al₂O₃) layer on the aluminum of chassis through a process of degreasing, rinsing, etching, polishing, rinsing, desmutting, rinsing, anodizing, rinsing, forming the polysiloxane layer 520 and drying, and forms a polysiloxane layer 520 on the aluminum oxide layer 510.

The chassis of the display apparatus according to the disclosed embodiment applies a ceramic layer such as polysiloxane as the last layer formed during the anodizing method, thereby simplifying the process and providing various colors and excellent surface hardness and corrosion resistance.

As illustrated in FIG. 5, the chassis surface of the display apparatus according to the disclosed embodiment includes an aluminum oxide layer 510 formed by an anodizing process on the aluminum 500 surface and a polysiloxane layer 520 formed on the aluminum oxide layer 510.

The aluminum oxide layer 510 formed on the aluminum 500 surface is formed by an anodizing method. The polysiloxane layer 520 formed on the aluminum oxide layer 510 may be formed by dipping or spraying method.

The polysiloxane layer 520 may be formed by applying a polysiloxane containing pigment onto the aluminum oxide layer 510 by the above-described dipping or spraying method. The polysiloxane constituting the polysiloxane layer 520 may be composed of only polysiloxane or a combination of acrylic and polysiloxane.

The pigment included in the polysiloxane layer 520 may include at least one of white pigment, blue pigment, green pigment, and yellow pigment. The white pigment may include at least one of White Lead, Zinc Oxide, Zinc Sulfide, Antimony Oxide and Titanium Oxide The blue pigment may include at least one of 2CoO.Cr₂O₃.Al₂O₃, CoO.Al₂O₃ and Copper Phtalocyanine. The green pigment may include at least one of Chloride Copper Phthalocyanine and Bromide Copper Phthalocyannine. The yellow pigment may include at least one of Lead Chromate (PbCrO₄), Lead Sulfate (PbSO₄), Cadmium Sulfide, Hydrated Ferric Oxide (Fe₂O₃.H₂O) and BaCrO₄. The above-mentioned color and type of pigment are only examples, and the color or type of pigment is not limited thereto.

In general, the anodizing method includes coloring and sealing processes as separate processes, as described above. However, in the anodizing method according to the disclosed embodiment, it is possible to implement color while replacing the coloring process and the sealing process performed in separate processes with a single process of forming a polysiloxane containing pigment on an aluminum oxide layer 510.

Although a few embodiments of the present disclosure have been shown and described, it would be appreciated by those skilled in the art that changes may be made in these embodiments without departing from the principles and spirit of the disclosure, the scope of which is defined in the claims and their equivalents.

1. A display apparatus comprising:
a display panel; and
a chassis disposed on the outside of the display panel, and
wherein the chassis comprises an aluminum oxide layer; and a polysiloxane layer disposed on the aluminum oxide layer, on its surface.

2. The display apparatus according to claim 1, wherein the polysiloxane layer further comprises an acrylic.

3. The display apparatus according to claim 1, wherein the polysiloxane layer comprises at least one of a white pigment, a blue pigment, a green pigment and a yellow pigment.

4. The display apparatus according to claim 1, wherein the polysiloxane layer comprises a white pigment comprising at least one of a white lead, a zinc oxide, a zinc sulfide, an antimony oxide and a titanium oxide.

5. The display apparatus according to claim 1, wherein the polysiloxane layer comprises a blue pigment comprising at least one of 2CoO.Cr₂O₃.Al₂O₃, CoO.Al₂O₃ and copper phtalocyanine.

6. The display apparatus according to claim 1, wherein the polysiloxane layer comprises a green pigment comprising at least one of chloride copper phthalocyanine and bromide copper phthalocyannine.

7. The display apparatus according to claim 1, wherein the polysiloxane layer comprises a yellow pigment comprising at least one of lead chromate (PbCrO₄), lead sulfate (PbSO₄), cadmium sulfide, hydrated ferric oxide (Fe₂O₃.H₂O) and BaCrO₄.

8. A manufacturing method of a display apparatus comprising:
forming an aluminum oxide layer by performing anodizing on the chassis surface of the display apparatus; and
forming a polysiloxane layer on the aluminum oxide layer by using pigment and polysiloxane.

9. The manufacturing method according to claim 8, wherein the polysiloxane layer further comprises an acrylic.

10. The manufacturing method according to claim 8, wherein the forming the polysiloxane layer comprises:
forming the polysiloxane layer on the aluminum oxide layer using a dipping or spray method.

11. The manufacturing method according to claim 8, wherein the pigment comprises at least one of a white pigment, a blue pigment, a green pigment and a yellow pigment.

12. The manufacturing method according to claim 8, wherein the pigment comprises a white pigment comprising at least one of a white lead, a zinc oxide, a zinc sulfide, an antimony oxide and a titanium oxide.

13. The manufacturing method according to claim 8, wherein the pigment comprises a blue pigment comprising at least one of 2CoO.Cr₂O₃.Al₂O₃, CoO.Al₂O₃ and copper phtalocyanine.

14. The manufacturing method according to claim 8, wherein the pigment comprises a green pigment comprising at least one of chloride copper phthalocyanine and bromide copper phthalocyannine.

15. The manufacturing method according to claim 8, wherein the pigment comprises a yellow pigment comprising at least one of lead chromate (PbCrO₄), lead sulfate (PbSO₄), cadmium sulfide, hydrated ferric oxide (Fe₂O₃.H₂O) and BaCrO₄.
